(19) United States
(12) Patent Application Publication
(10) Pub. No.: US 2014/0355905 A1
(43) Pub. Date: Dec. 4, 2014

(54) PHOTO MOSAIC SYSTEMS AND METHODS

(71) Applicants: Michael William Lipton, Brooklyn, NY (US); Mattias Hans Gunneras, Brooklyn, NY (US); Andrew Stephen Zolty, Brooklyn, NY (US)

(72) Inventors: Michael William Lipton, Brooklyn, NY (US); Mattias Hans Gunneras, Brooklyn, NY (US); Andrew Stephen Zolty, Brooklyn, NY (US)

(21) Appl. No.: 14/286,187

(22) Filed: May 23, 2014

Related U.S. Application Data
(60) Provisional application No. 61/829,213, filed on May 30, 2013.

(51) Int. Cl. G06T 11/60

(52) U.S. Cl. CPC G06T 11/60; G06T 2200/32
USPC 382/284

(57) ABSTRACT

Systems and methods for creating a photo mosaic are disclosed. The system and methods may generate a photo mosaic from user generated/submitted content. The system has an image collection module, an image processing module, an image placement module, and a display module. The photo mosaics created by the system and methods of the invention may be generated in real time. The system and methods may be particularly useful for the purposes of advertising and/or the creation of a bespoke art piece at a live event.

### STATEMENT REGARDING FEDERALLY SPONSORED RESEARCH

N/A

### FIELD OF THE INVENTION

The present invention relates to devices, systems and methods for the creation and presentation of photo mosaic images.

### BACKGROUND

Photo mosaics are compound images that have become popular in recent years. Manually compiling photo mosaics is a time consuming and difficult process. Various digital methods have been developed to aid in the automated creation of photo mosaics, such as are embodied in U.S. Pat. Nos. 5,649,032 & 6,137,498 both of which are hereby incorporated by reference. Nevertheless, the methods currently available are associated with several shortcomings and limitations. To address these shortcomings and limitations the following is disclosed

### SUMMARY

Systems and methods for creating a photo mosaic are disclosed. The system and methods can generate a photo mosaic from user generated/submitted content. The photo mosaics created by the system and methods of the invention can be generated in real time. The system and methods may be particularly useful for the purposes of advertising and/or at live events.

An embodiment is a method for advertising a promotional object by creating a photo mosaic made up of a plurality of individual image “cells” arranged to form a target image including: selecting a target image for the photo mosaic wherein the target image for the photo mosaic is related to the promotional object, collecting a plurality of images to form a plurality of individual cells of the photo mosaic wherein the plurality of individual images are collected from a plurality of users, processing the plurality of individual images to determine where to place them to form the target image, and causing the plurality of images to be placed so as to form the target image.

An embodiment is a method for the real time creation of a photo mosaic at an event including selecting an event in which the real time photo mosaic is to be created, selecting a target image, installing a canvas at the event in which the real time photo mosaic is to be created, wherein the canvas further comprises a grid and the grid is further made up of a plurality of discrete grid locations and wherein the plurality of discrete grid locations are each assigned a value indicator and the grid is laid out to define the target image, collecting a plurality of images from a plurality of users, processing the plurality of images from the plurality of users so as to give each image an accuracy score and/or a quality score, and causing the plurality of images to be placed on the canvas so as to form the target image.

An embodiment is a system for creating a photo mosaic from user generated content including a canvas divided into a grid with discrete grid locations such that each grid location is assigned a value so that when individual images are placed on the canvas a target image will be formed, an image collection module for the collection of a plurality of images from a plurality of users, an image processing module for assigning an accuracy score and/or a quality score to each of the plurality of images, and an image placement module for the placement of the plurality of images onto the canvas.

### BRIEF DESCRIPTION OF THE DRAWINGS

FIG. 1 shows an example of a target image and an example of a photo mosaic of the target image.

FIG. 2 shows a schematic diagram of the elements of a system for forming a photo mosaic from user generated content.

FIG. 3 shows a flow diagram illustrating a method of forming a photo mosaic at an event.

FIG. 4 shows a flow diagram illustrating a method of forming a photo mosaic from user generated content.

FIG. 5 shows a flow diagram illustrating a method of forming a photo mosaic from user generated content.

FIG. 6 shows the process of printing out an image and having a user place it on a canvas at a designated grid location.

### DETAILED DESCRIPTION

Photo mosaic systems and methods according to various embodiments will hereinafter be described by disclosing specific examples. Respective working examples, which will be given below, are exemplifications, and the present invention is not limited to configurations in the working examples.

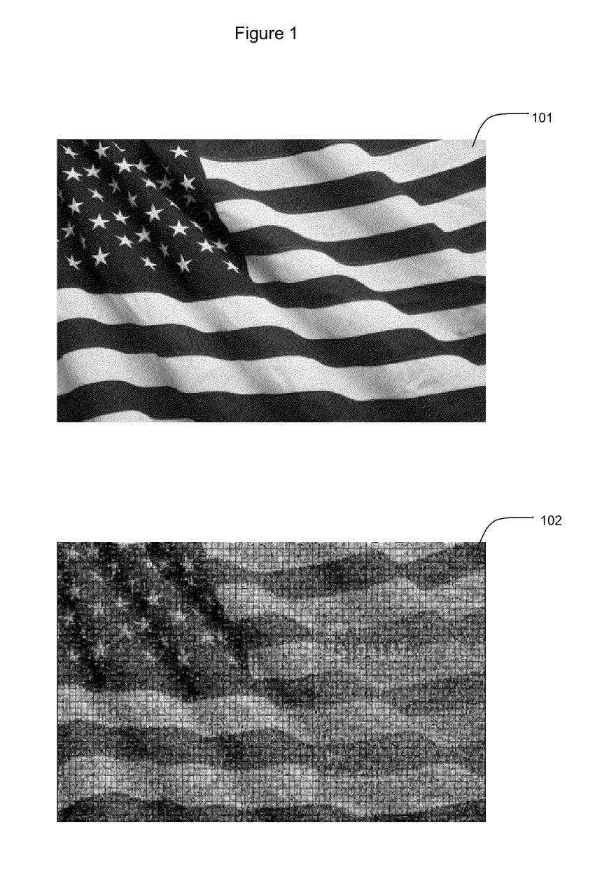

FIG. 1 shows an example of a target image (101) and a photo mosaic of the target image (101). Given a defined target image the systems and methods described herein will create a pixel art or other suitable mosaic of that image in real time over a defined period of time from a crowd sourced, user generated stream of images. For example, given target image (101), the system and methods of the present invention will produce a composite photo mosaic image (101) formed by an arrangement sub images or “cells” wherein all or part of the sub images or “cells” have been contributed by users. User contribution of sub images or “cells” is effectuated by any image collection scheme known to those having skill in the art, as in, for example, by being pulled from images uploaded by a wide audience to a social network (Facebook, Instagram, Twitter or the like), photo sharing application, electronic message (email, text message or the like) or local method such as by coupling to a client system. By constructing the image in real time, users can see their photos being added to the mosaic only moments after the photos are taken.

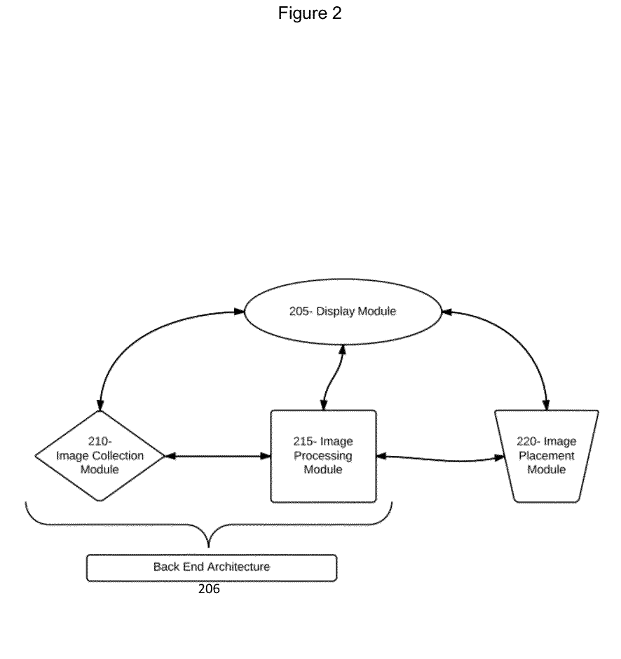

FIG. 2 shows a schematic diagram of the elements of a system for creating a photo mosaic image from user generated content. The system comprises a back end architecture (206) which further comprises at least an image collection module (210) and a image processing module (215). The back end architecture may include a computer system capable of communicating with users, such as a central web server, a database capable of storing and interacting with images and parameters such as rules or logic for creating the photo mosaic. The computer system coordinates the following parts of the photo mosaic creation: image gathering, image processing and scoring, logic for mosaic construction and grid positioning, providing an interface for a software client to access photo mosaic data, providing an administrative interface for setting up photo mosaic instances and parameters, providing for photo mosaic embedding in 3rd party websites, and providing analytics of user participation in the photo mosaic creation.

The image collection module (210) of the back end architecture (206) fetches images and image meta data from a plurality of users via any method known to those having skill in the art, such as, for example, social networks or other online media storage facilities, or locally from previously uploaded images. Image data, visual pre-processing data about image structure and other relevant data about the images is stored in the central database for the application. The image collection module collects photos from users for example, by being pulled from images uploaded by a wide audience to a social network (Facebook, Instagram, Twitter or the like), photo sharing application, electronic message (email, text message or the like) or local method such as by direct upload from a camera or by coupling to a client system and/or having users input their photos via a portable storage modality such as, for example an SD or Micro SD card.

The image processing module (215) processes and scores the images that are received. For each new image that is added to the database it is compared to every cell in the grid. The system compares each image to the contents of each given grid cell from the original target image and determines how closely the received image matches the contents of the grid cell. This matching is defined by the properties of the received images, such as, but not limited to: color, hue, shading, shape and any other parameters known to those skilled in the art by which to judge the equivalency or similarity of a plurality images. The output of this process is a number that indicates the level of accuracy (i.e. an “accuracy score”) that the received image has to the section of the reference image (“discrete grid location”) against which it is being compared. For each image that is received by the system, an accuracy score for that image will be generated for each discrete grid location (regardless of if the discrete grid location is currently occupied by an image or not). These values are returned as an array whose size is the width x height of the grid.

In order to ensure a high quality end result, the system will set a minimum “accuracy score” that should be met by an image before it is placed in the mosaic. The system will only place (or assign) images into the mosaic if their accuracy score is higher than the pre-determined threshold. If a given cell is currently occupied, and an incoming photo has an accuracy score that is both above the quality threshold and also above the accuracy score of the current image, the new image may replace the current image in order to improve the overall quality of the mosaic. Since replacing images isn't always desired, this behavior may be strictly limited, or only allowed if the new image's score exceeds the current image's score by a certain degree.

Quality thresholds can be set on a global (e.g. affecting the entire photo mosaic) or regional basis (affecting only a defined portion of the photo mosaic). Regional values can be defined if there are parts of the target image that require higher fidelity. For example in a target image comprising a blurry element, such as a background, and a focused element, such as a face, the system may define the region of the face to require higher scores than the background. This means the software will be more selective about the images that go into the face region than what goes into the blurry background region. Quality thresholds can also be set based on the source of the images. For example, images that are pulled in from one hashtag may be more desirable to have included in the work, and will therefore need a lower quality score to be included.

Sometimes a need will arise to make a very large mosaic out of relatively few images. In these cases the system can repeat the number of instances that each image will be included in the mosaic (e.g. the system can allow each image to be used up to 10 times should it have an accuracy score that eclipses the quality threshold for multiple grid cells).

The system may also include a proximity parameter that will set a minimum distance between repeated images. That is, if the system allows two of the same image to be included in the mosaic, it would not allow them to appear adjacent to each other as this will degrade the overall quality of the final result.

At an event where a real-time mosaic is to be displayed (either by printing out each image and fixing it on a surface, or displaying it digitally,) there is a computer that runs a software client program that is operatively coupled to the central mosaic web server. The client receives instructions from the web server about which images to print (in a physical embodiment) and/or display (in a digital embodiment.)

Any mosaic created by the systems and methods described herein may be live streamed over the web or otherwise made available using interactive technologies. For example, 3rd party websites can embed a mosaic onto their pages by linking to a URL on the mosaic server. For example this could be done via an HTML iframe or by embedding an Adobe Flash movie or a JavaScript file that pulls in the relevant resources to the page and displays the mosaic or by any other method known to those having skill in the art. Through this method, a real time mosaic can be live anywhere online and update in real time as it is created.

The display module (205) is the canvas on which is displayed the photo mosaic image as it is created. The display module can be a digital display or a physical canvas. The display module (205) may be any display technology known to those having skill in the art, such as, for example a digital display like a computer monitor, LED, LCD, plasma screen, a projected image, or the like. In the case where digital displays are used, the grid will preferably not be visible on the display, but rather defined by software. Alternatively a physical display such as board may be used in embodiments where the plurality of images are to be printed out and physically attached to the display by users or operators. In the case of a physical display, the grid will preferably be visible and suitably marked so as to give users and/or operators sufficient information as to where to place the printed images. For example the board or other suitable display may be overlaid with a Cartesian grid and each location in the grid may be assigned Cartesian coordinates or other suitable identifier.

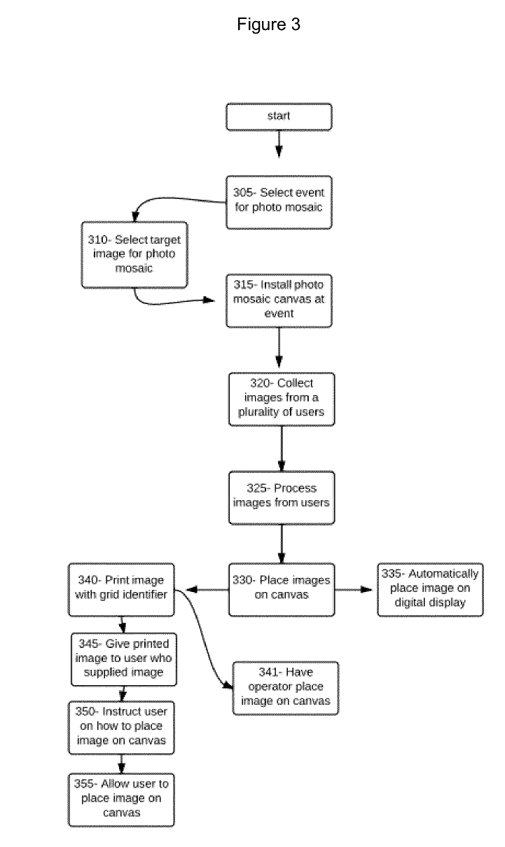

Turning now to FIG. 3 in which an embodiment of the method is shown. The embodiment is a method for the real time creation of a photo mosaic at an event comprising the steps of selecting an event at which the photo mosaic is to be created and displayed (305), installing a canvas at the event (315) in which the real time photo mosaic is to be created, wherein the canvas further comprises a grid, the grid further comprising a plurality of discrete grid locations or “cells” and wherein the plurality of discrete grid locations are assigned a value, wherein the value is the quantitative description of that portion of the target image within the discrete grid location, and the grid being laid out to correspond to a target image which has been selected (310); collecting a plurality of images from a plurality of users (320); processing the plurality of images from the plurality of users (325); and causing the plurality of images from a plurality of users to be placed on the canvas (330) so as to form the target image.

An embodiment is a method for advertising a promotional object through the creation of a photo mosaic formed from a plurality of individual photo cells. The step of the method wherein a target image is selected (310) may further comprise selecting the image in order to advertise a promotional object. A promotional object can be any product, service, issue, or other object about which an entity wishes to draw attention. Once selected, the target image is added to the system and will dictate the appearance of the final photo mosaic. Parameters used to construct the photo mosaic include, but are not limited to, size of the final photo mosaic, size of the individual grid cells that make up the mosaic image, image repeat count, image repeat proximity, global and regional quality thresholds, sources for images, and other pre processing parameters. In other embodiments, the photo mosaics may be presented for non promotional purposes, such as, for example at weddings, office building lobbies, or as a piece of memorabilia or art.

The canvas may be any display technology known to those having skill in the art, such as, for example a digital display like a computer monitor, LED, LCD, plasma screen, a projected image, or the like. In the case where digital displays are used, the grid will preferably not be visible on the display, but rather defined by software. Alternatively a physical display such as board may be used in embodiments where the plurality of images are to be printed out and physically attached to the display by users or operators. In the case of a physical display, the grid will preferably be visible and suitably marked so as to give users and/or operators sufficient information as to where to place the printed images. For example the board or other suitable display may be overlaid with a Cartesian grid and each location in the grid may be assigned Cartesian coordinates or other suitable identifier.

The plurality of images that will make up the individual cells of the photo mosaic can be collected from a plurality of users in any way known to those having skill in the art. Of particular interest are automated collection schemes and electronic delivery schemes. In the case of an automated collection scheme, a hashtag (“#”) collection paradigm is an illustrative example, as are subscribing to geo-tags or specific user accounts. In a hashtag collection paradigm, a computer program monitors all images uploaded to a website that are tagged with a particular hashtag and imports those images to a database for incorporation into the photo mosaic. In an electronic delivery scheme, images may be input to the photo mosaic system by delivering the images to the system via electronic messaging. Illustrative examples of suitable electronic messaging modalities appropriate for an electronic delivery scheme are email, SMS (text) messaging, or the like. Alternatively images may be collected locally, at the event where the photo mosaic is being displayed. A local collection scheme may involve the transfer of digital images by any local transfer modalities known to those having skill in the art, such as, for example, by connecting users' image capture devices to the photo mosaic system via a wired (USB) or wireless connection (Bluetooth). Local transfer of images can also be effectuated by using removable media storage modalities such as SD cards, micro SD cards, portable flash drives and the like.

The image processing step includes the aspects of the method that evaluate the plurality of images submitted by a plurality of users and assess the images' suitability for incorporation into the photo mosaic. Each image that is added to the database is compared to every cell in the grid. The system compares each image to the contents of each given grid cell from the original target image and determines how closely the received image matches the grid cell. This matching is defined by the properties of the received images, such as, but not limited to: color, hue, shading, shape and any other parameters known to those skilled in the art by which to judge the relative equivalency or similarity of a plurality images. The output of this process is a number that indicates the level of accuracy (i.e. an “accuracy score”) that the received image has to the section of the target image (“discrete grid location”) against which it is being compared. For each image that is received by the system, an accuracy score for that image will be generated for each discrete grid location (regardless of if the discrete grid location is currently occupied by an image). These values are returned as an array whose size is the width x height of the grid.

In order to ensure a high quality end result, the system will set a minimum “accuracy score” that should be met by an image before it is placed in the photo mosaic. The system will only place (or assign) images into the photo mosaic if their accuracy score is higher than a pre-determined threshold. If a given cell is currently occupied, and an incoming photo has an accuracy score that is both above the quality threshold and also above the accuracy score of the current image, the new image can replace the current image in order to improve the overall quality of the mosaic. Since replacing images isn't always desired, this behavior may be strictly limited, or only allowed if the new image's score exceeds the current image's score by a certain degree.

Quality thresholds can be set on a global (e.g. affecting the entire photo mosaic) or regional basis (affecting only a defined portion of the photo mosaic). Regional values can be defined if there are parts of the target image that require higher fidelity. For example in a target image comprising a blurry element, such as a background, and a focused element, such as a face, the system may define the region of the face to require higher scores than the background. This means the software will be more selective about the images that go into the face region than what goes into the blurry background region.

Sometimes a need will arise to make a very large mosaic out of relatively few images. In these cases the system can repeat the number of instances that each image will be included in the mosaic (e.g. the system can allow each image to be used several times should it have an accuracy score that eclipses the quality threshold for multiple grid cells).

The system may also include a proximity parameter that will set a minimum distance between repeated images. That is, if the system allows two of the same image to be included in the mosaic, it would not allow them to appear adjacent to each other as this will degrade the overall quality of the final result.

The step of causing the plurality of images to be placed on the canvas (330) so as to form the target image may be accomplished in a variety of ways. In the case of a digital display, the images may be placed automatically into the digital display (335) by the system in accordance with the received image's accuracy score and/or quality score. In the case of a physical display the plurality of images, once processed, can be added to a print queue and printed out (340) on an associated printer. The printed image should also be annotated with the appropriate grid coordinate into which the printed image should be placed. Placement of the printed images into the grid can be accomplished by incorporating a connector on a back side of the printed image. Any connector known to those having skill in the art may be used, such as, for example, adhesive, hook and loop connectors, magnetic connectors or the like. Once printed out, the images may be placed into the grid on the canvas by a system operator (341). Alternatively, to further engage users, the printed image can be given to the user who provided the image (345) along with instructions on how to place the image into the grid on the canvas (350) and allowing the user to place the image into the grid (355).

The steps of the method can be done in real time, allowing the photo mosaic to be formed, one cell at a time at the event and allowing attendees at the event, or users viewing remotely, to watch as the photo mosaic forms.

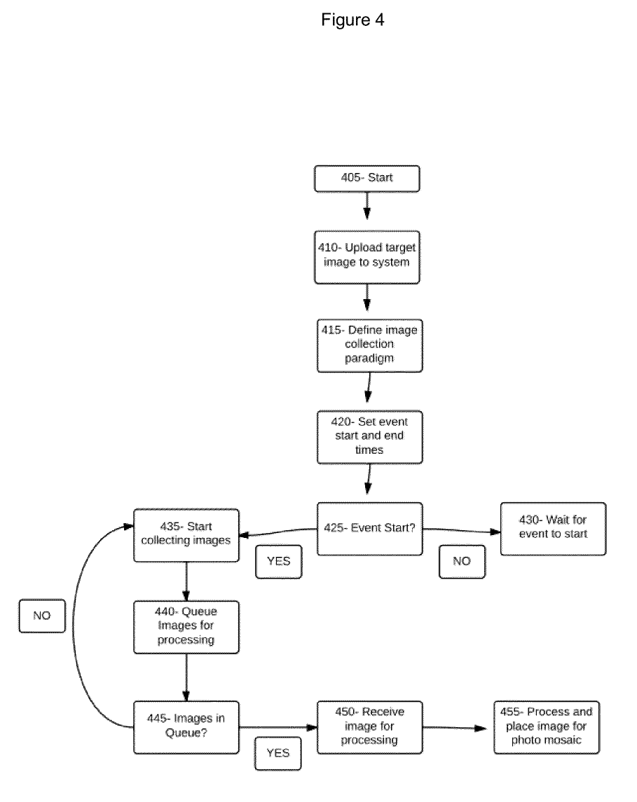

Turning now to FIG. 4 which shows a flow chart representing steps in a method for using the system for creating a photo mosaic in real time from user submitted content. The method comprises the steps of uploading a target image to the system (410). Next an image collection paradigm is defined in the system (415). Any of the image collection paradigms described herein can be used. Next, the start and end times of the photo mosaic creation period are set (420). Next, the system queries whether the start time of the photo mosaic creation period has been reached (425). If the start time of the photo mosaic creation period has not been reached, the system will wait (430). If the start time of the photo mosaic creation period has been reached, the system will start collecting images (435) according to the defined image collection paradigm. Next the system will queue the collected images for processing (440). Next the system will query whether there are images in the queue waiting to be processed (445). If there are no images in the queue waiting to be processed, the system will continue collecting images. If there are images in the queue waiting to be processed, the system will receive the next image in the queue for processing (450). Once the image is received, it is processed according the methods previously described and placed on the photo mosaic canvas (455) according to the methods previously described, in order to form the target image.

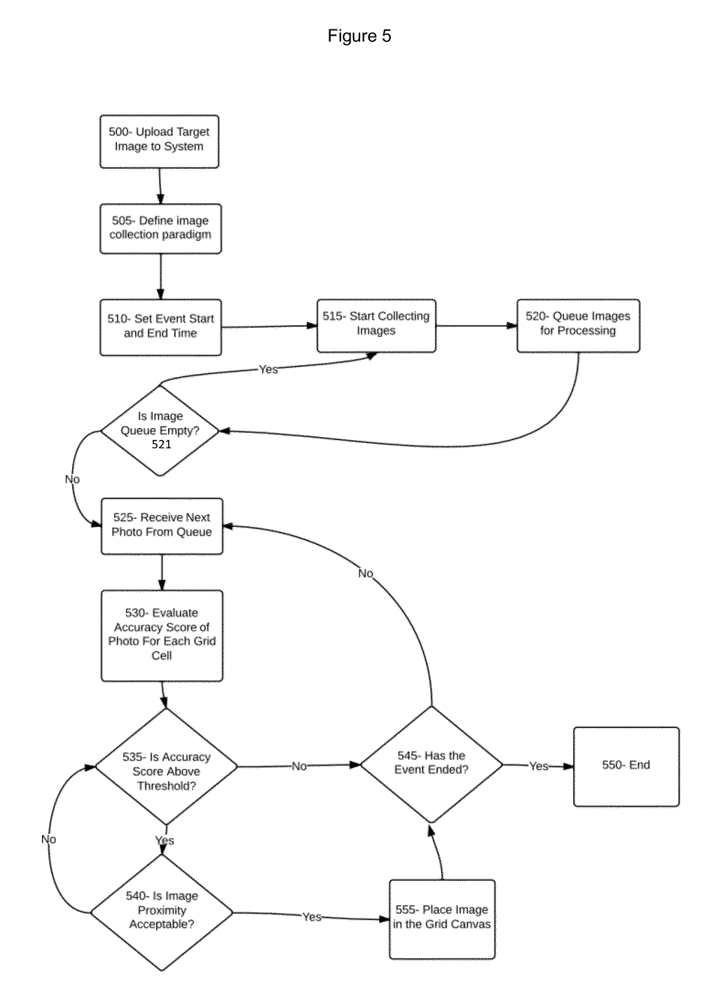

Turning now to FIG. 5 which shows another flow chart representing steps in a method for using the system for creating a photo mosaic in real time from user submitted content. The method comprises the steps of uploading a target image to the system (500). Next an image collection paradigm is defined in the system (505). Any of the image collection paradigms described herein can be used. Next, the start and end times of the photo mosaic creation period are set (510). Once the start time of the photo mosaic creation period has been reached, the system will commence with collecting images (515) according to the defined image collection paradigm. Once collected, the images are queued for processing (520). Next, the system queries whether the image queue is empty (521). If the image queue is empty, the system will continue collecting images. If the image queue is not empty, meaning that there is at least one image that has been collected and placed in the queue, the system will receive the next image in the queue for processing (525). Processing comprises at least evaluating the accuracy score for each image for each grid cell (530). Next the system queries whether the accuracy score for the image is above a threshold level (535). If the accuracy score for the image is above the threshold level, the system queries whether the image proximity value is acceptable (540). If the proximity value is acceptable, the image will be placed on in the grid on the canvas (555). Next the system queries whether the photo mosaic creation period has ended (545). If the photo mosaic creation period has ended, the method will stop (550). If the photo mosaic creation period has not ended, the system will continue with the method by receiving the next image from the queue (525).

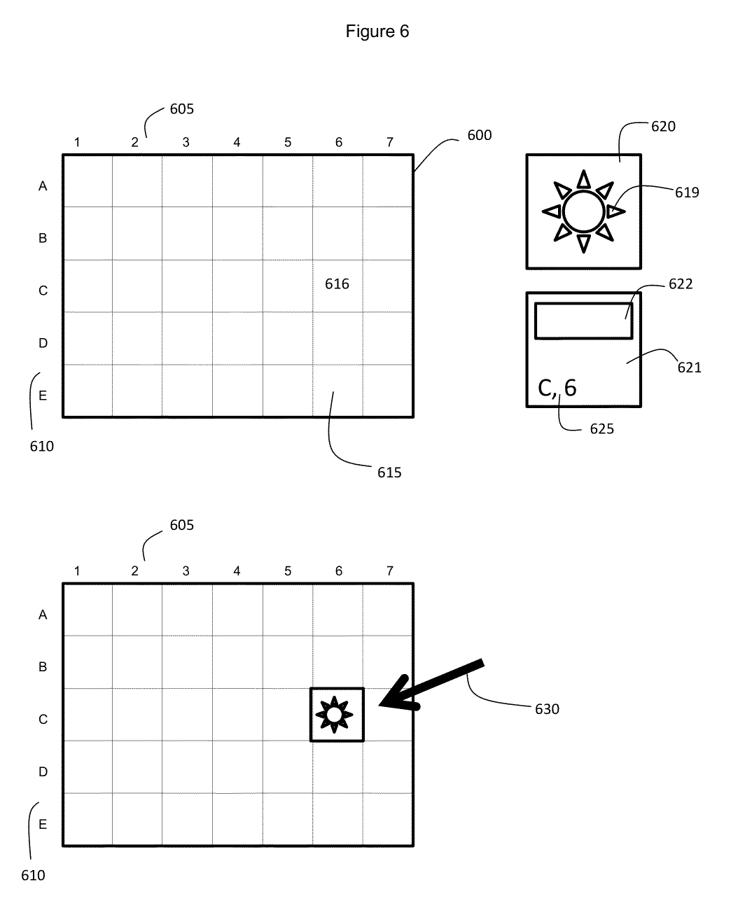

Turning now to FIG. 6. FIG. 6 shows the process of printing out an image and having a user place it on a canvas at a designated grid location. A canvas, in this case a board installed at an event, (600) is divided into a plurality of discrete grid locations (615). The grid locations are designated by a Cartesian coordinate system comprising an X-axis (605) and a Y-axis (610) such that any discrete grid location can be identified by its Cartesian coordinate position by designating it as (X, Y). When the system receives an image from a user, the image is processed according the methods of the system to determine where on the grid it should be placed so as to form the target image. The image is then printed out such that the user's image (619) is on the front side of the print-out (620) and the position of where on the canvas the image is to be placed (616) is printed as a Cartesian coordinate (625) on the back of the print-out (621). The user may then be instructed on how to place the image onto the canvas such as, for example, by engaging an adhesive (622) on the back side of the printed image. The user will then be allowed to place the image at the designated location (630).

Another embodiment is a method for incentivizing user participation in an advertising campaign comprising the steps of defining an image related to a promotional purpose, establishing a photo mosaic creation scheme in accordance with the systems, devices and methods described herein, and inviting users to participate by submitting images such that the faster users submit images, the sooner the image related to the promotional purpose will be revealed. The image related to a promotional purpose may be an image of a new product, or an update of a product about which the public has an interest.

Since, at least in some cases, the photo mosaic is being created during a set time period, it is not possible to know the volume, quality or subject of the photos that will be received. Therefore it is difficult to anticipate the correct global quality threshold that should be set. If the threshold is set too low, the end result will be of poor visual quality. If it is set too high, the system may not receive enough images with a high enough score to fill all of the grid cells. In order to combat this, the system is able to update the global quality threshold at any point throughout the photo mosaic creation period. This will allow for a higher percentage of photos to be placed into the mosaic and will result in the mosaic being completed in less time. Also, there is the ability to recycle through the existing pool of images. This allows the system to update the quality threshold retroactively. For example, at a two day event, where the system is building a 10×10 mosaic, (which means there are 100 grid slots to fill,) the system begins with a global threshold of 500. For example, on the first day, the system receives 300 photos, of which 10% had an accuracy score of 500 or better. At the end of that day, the system will have placed 30 photos and still have 70 empty slots. The system can adjust the global threshold to allow more photos to come through on day 2. If the system adjusts that threshold to 400, which will allow more photos to be placed on the grid as they are taken, but there are also 300 photos in the database from the first day of the event. By “recycling” the images with the new threshold of 400, the system will also place any of those Day 1 images with a score between 400 and 500 on the grid. These images would not have been placed on day 1 since they did not meet the quality threshold that had been set at that point.

Another valuable asset that is created through this system is the capturing of metrics about the mosaic. Users of the system will be able to track the number of photos that are submitted, the number and percentage of photos that are used, the method through which the images were received (via which specific social network/hashtag, etc), the time that the photos were taken, the location from which the photos were taken and the like. This will give valuable insight into the effectiveness of targeted advertising.

In order to create a more engaging experience for users who submit images, it may be desirable to include functionality whereby users can identify their image(s)once it has been incorporated into the photo mosaic. A user interface may be provided wherein users can input a personal identifier that is associated with the image they have submitted. The identifier may be any data associated with the submitted image, such as, for example, a social network username, a phone number, a name, an email address or the like. The relevant identifying data may be associated with the image stored in the system by any method known to those skilled in the art, such as, for example as part of the meta data stored with the image. In the case of the physical mosaic, once the user inputs the identifier the coordinates associated with that image can be provided for the user. In the case of the digital mosaic, a highlighting feature may be presented to identify the image in the mosaic, such as, for example, by creating a border around the image, causing the image to flash, causing the image to enlarge, causing the image to brighten, causing the non identified images to darken, or any other method known to those skilled in the art for drawing attention to an image or part thereof. This experience could coincide with the construction of the mosaic or it may additionally exist indefinitely after the construction has completed to serve as an archive of the activation.

With respect to calculating an accuracy score for the creation of the photo mosaic, some embodiments can use existing engines or algorithms for ranking each incoming image. By way of illustrative example, Metapixel is a program for generating photo mosaics. It can generate classical photo mosaics, in which the source image is viewed as a matrix of equally sized rectangles for each of which a matching image is substituted, as well as collage-style photo mosaics, in which rectangular parts of the source image at arbitrary positions (i.e. not aligned to a matrix) are substituted by matching images. Individual aspects of the software may be used to generate coefficients on the image to calculate how close the incoming image is in color and form to every single cell of the target image. To do this, a coefficient table for the target image is done in two steps: first the system steps through the pixels in the image to create a set of wavelet coefficients on the image. The same process is performed on individual grid cells of the target image so that the sets can be correlated and the best fit for the image into the grid forming the target image can be determined. Second, a subpixel correlation metric is performed. This algorithm looks at all pixels in the graphic, including color in a YIQ color format which is tuned to how the human eye perceives color. The algorithm walks through all pixels in the incoming image and the target image and sums up a score for the “closeness” of color in the YIQ color space. I.e. an image that has colors that are perceived to be closer together for a human eye, gets a better likeness score.

In some embodiments, the photo mosaics may be constructed at non-event scenarios. In those scenarios, the mosaics can optionally be constructed over a longer period of time than at an event. Examples include an installation in a hotel lobby, museum, or cafe or other suitable location, where the emphasis is on the construction of an art piece (which still may be a promotional object) over the span of weeks or months. The mosaic may be constructed in a private space, such as, for example, a warehouse or an office. In embodiments where the mosaic is constructed in a private space, the mosaic may additionally be live streamed to the public via the web. Such embodiments would allow people to contribute from anywhere in the world and see their contributions added to the mosaic.

In some embodiments, take-away products can be provided to users or other customers. These take-aways could include flat prints of the entire mosaic, or printed canvases (up to full-scale) that can be assembled by the consumer. These can be of the same size as the original piece, smaller desktop prints or anything in between. Orders for the take-aways could be placed at events or via any other commercial channel known to those having skill in the art.

In some embodiments the photo mosaics can be permanent or semi permanent installations. This can be accomplished by printing the photo mosaic on an existing permanent structure, such as, for example a wall. In other embodiments, the individual grid cells can be printed on tiles or onto on to a medium capable of being fixed to tiles which can then be assembled into a durable, long lasting, and/or permanent photo mosaic. In other embodiments, a plurality of small digital displays, such as user cell phones or other mobile devices could be used as the discrete grid cells to form the photo mosaic. In such embodiments, each digital display would be aware of its location in the grid and can have an image pushed to it.

### EXAMPLES

### Example 1

A shoe company (“ShoeCompany”) is going to unveil a new sneaker design in times square, but rather than unveil it all at once, they will let it become public by incentivizing people to contribute their photos to a mosaic depicting an image of the design. The company may place advertisements world wide asking people to submit photos via social networks with #shoecompany. As photos are taken, they are evaluated for fit into the mosaic, and placed on the grid if appropriate. The more photos that are taken, the faster the new sneaker design will be unveiled.

### Example 2

An eyewear company (“RB”) is sponsoring Lollapalooza and as part of their brand area they want to showcase a mosaic being created in real-time from the photos that concert-goers are taking They will advertise specific hashtags (e.g. #lollapalooza, #RBatLolla, etc) to incentivize people to add those tags to photos that they are submitting via social networks (e.g. Instagram, facebook, etc). As the photos are submitted, if they are appropriate for inclusion in the mosaic, they will be printed out in real time, as they are uploaded and added to the correct location on the canvas. The end result will be a bespoke art piece that can be used for advertising or decoration. During the assembly of the mosaic, the nature of the final image (8) will not be known because the image is incomplete (5). This may provide an incentive for users to submit more photos.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

All references cited herein, including all patents, published patent applications, and published scientific articles, are incorporated by reference in their entireties for all purposes.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

What is claimed is:

1. A method for advertising a promotional object by creating a photo mosaic formed of a plurality of individual photo cells comprising:
selecting a target image for the photo mosaic wherein the target image for the photo mosaic is related to the promotional object;
collecting a plurality of images to form a plurality of individual cells of the photo mosaic wherein the plurality of images to form a plurality of individual cells of the photo mosaic are collected from a plurality of users;
processing the plurality of images from users in order to determine where to place the plurality of images in order to form the target image;
causing the plurality of images to be placed so as to form the target image.

2. A method for the real time creation of a photo mosaic at an event comprising:
selecting an event in which the real time photo mosaic is to be created;
selecting a target image;
installing a canvas at the event in which the real time photo mosaic is to be created;
wherein the canvas further comprises a grid, the grid further comprising a plurality of discrete grid locations and wherein the plurality of discrete grid locations are assigned a value and the grid being laid out to correspond to the target image;
collecting a plurality of images from a plurality of users;
processing the plurality of images from a plurality of users to determine where the plurality of images should be placed on the grid to form the target image;
causing the plurality of images to be placed on the canvas so as to form the target image.

3. The method of claim 2 further comprising setting an event start time to indicate when to start collecting images.

4. The method of claim 2 wherein the target image is selected in order to advertise a promotional object.

5. The method of claim 2 wherein the canvas is a digital display.

6. The method of claim 2 wherein the canvas is a board and printed pictures are attached to the board to form the target image.

7. The method of claim 2 wherein the collecting the plurality of images from a plurality of users is effectuated using a hashtag collection paradigm.

8. The method of claim 2 wherein the collecting the plurality of images from a plurality of users is effectuated by having the plurality of users submit images via electronic delivery.

9. The method of claim 2 wherein the collecting the plurality of images from a plurality of users is effectuated by having the plurality of users submit images locally.

10. The method of claim 2 wherein the plurality of images are images captured at the event.

11. The method of claim 2 wherein the plurality of images are placed on the digital display canvas automatically according to programmed logic rules.

12. The method of claim 2 wherein an individual user's image is printed out such that the printed image is labeled with a discrete grid location and the individual user physically places the printed image on the canvas.

13. The method of claim 2 wherein the plurality of images are placed on the canvas as soon as they are processed.

14. A system for creating a photo mosaic from user generated content comprising:
a canvas divided into a grid with discrete grid locations such that each discrete grid location is assigned a value so that when a plurality of individual images are placed on the canvas, a target image will be formed;
an image collection module for the collection of the plurality of individual images from a plurality of users;
an image processing module for assigning a value indicator to each of the plurality of individual images;
an image placement module for the placement of the plurality of individual images onto the canvas.

15. The system of claim 14 wherein the canvas is a digital display.

16. The system of claim 14 wherein the canvas is a board.

17. The system of claim 14 further comprising a printer for printing out the plurality of images from a plurality of users such that the printed images can be physically placed on the canvas.
